(19) United States
(12) Patent Application Publication
(10) Pub. No.: US 2011/0073798 A1
(43) Pub. Date: Mar. 31, 2011

(54) HIGH THERMAL CONDUCTIVITY AND LOW DISSIPATION FACTOR ADHESIVE VARNISH FOR BUILD-UP ADDITIONAL INSULATION LAYERS

(76) Inventors: Yun-Chao YEH, Taoyuan Hsien (TW); Chung-Hao CHANG, Taoyuan Hsien (TW); Cheng-Nan YEN, Taoyuan Hsien (TW); Li-Hung LIU, Taoyuan Hsien (TW)

(21) Appl. No.: 12/567,296

(22) Filed: Sep. 25, 2009

(51) Int. Cl. C09K 5/00

(52) U.S. Cl. 252/74; 252/73

(57) ABSTRACT

A high thermal conductivity and low dissipation factor adhesive varnish for (build-up) combining additional insulation layers is disclosed to be used for high-density interconnected printed circuit boards or IC-package substrates and to be formed by well mixing an epoxy resin precursor, a bi-hardener mixture, a catalyst, a flow modifier, an inorganic filler with high thermal conductivity, and a solvent. The epoxy resin precursor is formed by mixing at least two epoxy resins with a certain ratio, where the at least two epoxy resins are selected from a group including a tri-functional epoxy resin, a rubber-modified or Dimmer-acid-modified epoxy resin, a bromide-contained epoxy resin, a halogen-free/phosphorus-contained epoxy resin, a halogen-free/phosphorus-free epoxy resin, a long-chain/halogen-free epoxy resin, and a bisphenol A (BPA) epoxy resin.

### TECHNICAL FIELD

The present invention relates to a high thermal conductivity and low dissipation factor adhesive varnish for build-up (combining) additional insulation layers. The adhesive varnish and cured-resin are advantageous in better thermal conductivity, better rheological property, better thermal stability, low dissipation factor, low cost, and high yield, and is suitable to use in high-density interconnected printed circuit boards or IC-package substrates.

### BACKGROUND

Recently, with the rapid development in electronic technology, various kinds of high-technology industries spring up. Consequently, many more new electronic products with humanized design and functions are developed to replace conventional ones. These new electronic products are designed to be lighter, thinner, shorter, and smaller. Each of these new electronic products has at least one main board that is composed of many electronic elements and circuit boards. The function of the circuit boards is to hold the electronic elements, which are electronically interconnected with each other. Presently, the circuit boards are usually printed circuit boards.

Printed circuit boards can interconnect electronic elements with each other to perform an integral function. Therefore, they are integral parts to electronic information products. The quality of designed printed circuit boards will not only directly affect the reliability of electronic products, but also influence the competitiveness of the system products. Accordingly, printed circuit boards are commonly called “Mother of electronic system products” or “Basis of 3C industry”.

Nowadays, according to the technology for manufacturing commercial circuit boards, information computers are mainly made of fiberglass-based material containing copper foil substrates (FR-4), where the FR-4s are immersed with flame resisting epoxy resin. The main advantages of FR-4 substrates include heat endurance, low dielectric constant, and being friendly to environment. In addition to having above features, high-frequency substrates are also advantageous in one aspect regarding dielectric loss (low dissipation factor). Recently, the best-known manufacturing process is a method using Resin Coated Copper (RCC) or a method of piling up laser drillable prepregs (LDPP). The method using RCC is first to coat a layer of dielectric layer onto the copper foil treated with roughening treatment and then bake the copper foil to semi-solidified stage (B-stage). The copper foil is cut into desired sized pieces. The pieces are piled up and then the pile is pressed. The method of piling up LDPP is first to have fiberglass layers immersed in glue and then bake it to B-stage. After that, pile up above fiberglass layers and press the pile. Finally, cut the pile into suitable sized pieces.

However, the method using RCC or the method of piling up LDPP is still not preferable since the adhesive varnish used in above methods has following shortcomings.

1. Holes cannot be fully filled because resin has poorer flowability.
2. Manufacturing cost is high when the signal transmittance is incomplete.
3. The thermal conductivity, thermal stability, and rheological property are poor.
4. The yield of manufactured printed circuit boards is decreased.
5. It is usually unable to fill the holes and coat the surface (or add layers) at the same time because the contained resin is limited.
6. It is difficult to manufacture thick copper printed circuit boards.

In order to overcome above shortcomings, inventor had the motive to study and develop the present invention. After hard research and development, the inventor use different formulations to produce adhesive varnish that have different functions, are friendly to environment, and have increased flexibility.

### SUMMARY OF THE DISCLOSURE

An object of the present invention is to provide a high thermal conductivity and low dissipation factor adhesive varnish for combining additional layers, which is advantageous in better thermal conductivity, low dielectric loss (i.e. low dissipation factor), better rheological property, better thermostability, low cost, and high yield.

In order to achieve above object, the present invention provides a high thermal conductivity and low dissipation factor adhesive varnish for build-up (combining) additional insulation layers, where the adhesive varnish is used for high-density interconnected printed circuit boards or IC-package substrates. The high thermal conductivity and low dissipation factor adhesive varnish for build-up (combining) additional insulation layers is formed by well mixing an epoxy resin precursor, a bi-hardener mixture, a catalyst, a flow modifier, an inorganic filler with high thermal conductivity, and a solvent. The epoxy resin precursor is formed by mixing at least two epoxy resins with a certain ratio and the epoxy resins are selected from a group including a tri-functional epoxy resin, a rubber-modified or dimmer-acid-modified epoxy resin, a bromide-contained epoxy resin, a halogen-free/phosphorus-contained epoxy resin, a halogen-free/phosphorus-free epoxy resin, a long-chain/halogen-free epoxy resin, and a bisphenol A (BPA) epoxy resin.

In practice, in order to form the epoxy resin precursor, the respective ratio: the tri-functional epoxy resin is no more than 50%; the rubber-modified or dimmer-acid-modified epoxy resin is no more than 50%; the bromide-contained epoxy resin is no more than 80%; the halogen-free/phosphorus-contained epoxy resin is no more than 90%; the halogen-free/phosphorus-free epoxy resin is no more than 90%; the long-chain/halogen-free epoxy resin is no more than 50%; and the bisphenol A epoxy resin is no more than 80%.

In practice, the amount of bi-hardener mixture is 2˜20 phr (parts per hundred of resins); the amount of the catalyst is 0.1˜5 phr; the amount of flow modifier is 0.1˜5 phr; the amount of inorganic filler with high thermal conductivity is 15˜45 phr; the amount of solvent is 3˜25 phr.

In practice, the bi-hardener mixture is formed by well mixing an amine hardener and an acid anhydride hardener. The ratio of the amine hardener is no more than 10% and the ratio of the acid anhydride hardener is no more than 30%.

In practice, the catalyst is an imidazole catalyst and the ratio thereof is no more than 10%.

In practice, the flow modifier is an acrylic acid copolymer or a modified acrylic acid copolymer (or Poly-acrylates), where the average molecular weight of above copolymers is 5,000˜200,000 and the ratio thereof is 0.05˜10%.

In practice, the inorganic filler with high thermal conductivity is selected from a group including silicon nitride (SiN), aluminum nitride (AlN), boron nitride (BN), silicon carbide (SiC), aluminum oxide (Al₂O₃), silicon oxide (SiO₂), magnesium oxide (MgO), zinc oxide (ZnO), beryllium oxide (BeO), aluminum hydroxide (Al(OH)₃), and aluminum silicate. The particle diameter of the inorganic filler is 1˜50 μm and the ratio thereof is no more than 90%.

In practice, the solvent is selected from a group including dimethyl formamide (DMF), dimethyl cyclohexylamine (DMCA), methyl ethyl ketone (MEK), and cyclohexanone.

The following detailed description describes with examples or embodiments for best understanding accompanying in conjunction with the drawings.

### BRIEF DESCRIPTION OF THE DRAWINGS

FIG. 1 shows a composition of an embodiment of a high thermal conductivity and low dissipation factor adhesive varnish for build-up (combining) additional insulation layers of the present invention.

### DETAILED DESCRIPTION

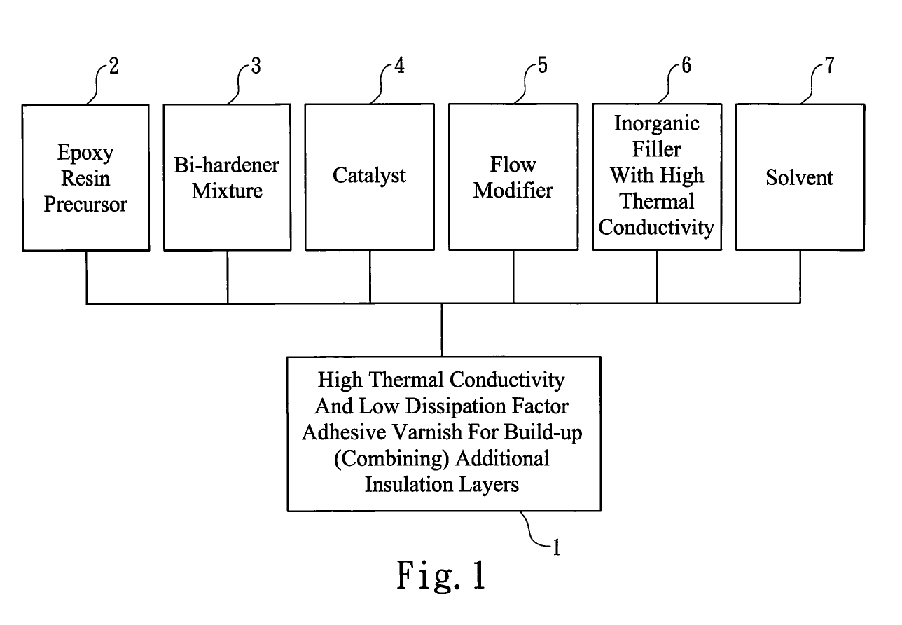

Please refer to FIG. 1 that shows an embodiment of a high thermal conductivity and low dissipation factor adhesive varnish for build-up (combining) additional insulation layers according to the present invention. The adhesive varnish is used for high-density interconnected printed circuit boards or IC-package substrates.

The high thermal conductivity and low dissipation factor adhesive varnish 1 for build-up (combining) additional insulation layers according to the present invention is formed by well mixing of an epoxy resin precursor 2, a bi-hardener mixture 3, a catalyst 4, a flow modifier 5, an inorganic filler 6 with high thermal conductivity, and a solvent 7.

The epoxy resin precursor 2 is formed by mixing at least two epoxy resins with a certain ratio and the epoxy resins are selected from a group including a tri-functional epoxy resin, a rubber-modified or Dimmer-acid-modified epoxy resin, a bromide-contained epoxy resin, a halogen-free/phosphorus-contained epoxy resin, a halogen-free/phosphorus-free epoxy resin, a long-chain/halogen-free epoxy resin, and a bisphenol A (BPA) epoxy resin.

Besides, in order to form the epoxy resin precursor, the respective ratio: the tri-functional epoxy resin is no more than 50%; the rubber-modified or Dimmer-acid-modified epoxy resin is no more than 50%; the bromide-contained epoxy resin is no more than 80%; the halogen-free/phosphorus-contained epoxy resin is no more than 90%; the halogen-free/phosphorus-free epoxy resin is no more than 90%; the long-chain/halogen-free epoxy resin is no more than 50%; and the bisphenol A epoxy resin is no more than 80%.

The bi-hardener mixture 3 is formed by well mixing an amine hardener and an acid anhydride hardener, where the ratio of the amine hardener is no more than 10% and the ratio of the acid anhydride hardener is no more than 30%. The catalyst 4 is an Imidazole catalyst and the ratio thereof is no more than 10%. The flow modifier is an acrylic acid copolymer or a modified acrylic acid copolymer (or Poly-acrylates), where the average molecular weight of above copolymers is 5,000˜200,000 and the ratio thereof is 0.05˜10%. The inorganic filler 6 with high thermal conductivity is selected from a group including silicon nitride (SiN), aluminum nitride (AlN), boron nitride (BN), silicon carbide (SiC), aluminum oxide (Al₂O₃), silicon oxide (SiO₂), magnesium oxide (MgO), zinc oxide (ZnO), beryllium oxide (BeO), aluminum hydroxide (Al(OH)₃), and aluminum silicate. The particle diameter of the inorganic filler is 1˜50 μm and the ratio thereof is no more than 90%. The solvent 7 is selected from a group including dimethyl formamide (DMF), dimethyl cyclohexylamine (DMCA), methyl ethyl ketone (MEK), and cyclohexanone. The amount of bi-hardener mixture 3 is 2˜20 phr (parts per hundred of resins); the amount of the catalyst 4 is 0.1˜5 phr; the amount of flow modifier is 0.1˜5 phr; the amount of inorganic filler 5 with high thermal conductivity is 15˜45 phr; and the amount of solvent is 3˜25 phr.

Accordingly, when in practice, one embodiment is disclosed in table 1 as follows. First, the epoxy resin precursor can be made by mixing following constitutes: tri-functional epoxy resin 10 phr, bisphenol A epoxy resin 30 phr, long-chain/halogen-free epoxy resin 5 phr, bromide-contained epoxy resin 30 phr, and rubber-modified or Dimmer-acid-modified epoxy resin 25 phr. The epoxy resin precursor obtained above is well mixed with filler (silicon nitride 20 phr, aluminum oxide 40 phr, and silicon oxide 40 phr), bi-hardener mixture 2.5 phr, Imidazole catalyst 0.25 phr, flow modifier (Acrylic acid copolymer (or Poly-acrylates) 2 phr), and solvent (Dimethyl formamide 20 phr) to form the high thermal conductivity and low dissipation factor adhesive varnish for build-up (combining) additional layers of the present invention. The viscosity of the adhesive varnish is 14,800 cps. The thermal conductivity of the cured adhesive varnish is 2.3 W/m-K and the dissipation factor thereof is 0.008(@1 GHz).

TABLE 1

| | | phr (by weight) | |
|---|---|---|---|
| Epoxy resin precursor | Tri-functional epoxy resin | 10 | (4.4%) |
| | Bisphenol A epoxy resin | 30 | (13.3%) |
| | Long-chain/halogen-free | 5 | (2.5%) |
| | epoxy resin | | |
| | Bromide-contained | 30 | (13.3%) |
| | epoxy resin | | |
| | Rubber-modified or | 25 | (11%) |
| | Dimmer-acid-modified | | |
| | epoxy resin | | |
| Filler | Silicon nitride | 20 | (8.9%) |
| | Aluminum oxide | 40 | (17.8%) |
| | Silicon oxide | 40 | (17.8%) |
| Hardener | Bi-hardener mixture | 2.5 | (1.1%) |
| Catalyst | Imidazole catalyst | 0.25 | (0.1%) |
| Flow modifier | Acrylic acid copolymer | 2 | (0.9%) |
| | (Or Poly-acrylates) | | |
| Solvent | Dimethyl formamide | 20 | (8.9%) |

| Thermal conductivity | 2.3 | (W/m-K) |
|---|---|---|
| Dissipation factor (@ 1 GHz) | 0.008 | |
| Glass transition temperature Tg | 155° | C. |
| Thermal degradation temperature Td | 325° | C. |
| Level of flame retardation | V-0 | |
| Viscosity of the adhesive varnish | 14800 | cps |

Alternatively, the adhesive varnish with high velocity can be made based on table 2. First, the epoxy resin precursor can be made by mixing following constitutes: tri-functional epoxy resin 10 phr, bisphenol A epoxy resin 25 phr, long-chain/halogen-free epoxy resin 5 phr, halogen-free/phosphorus-free epoxy resin 40 phr, and rubber-modified or Dimmer-acid-modified epoxy resin 20 phr. The epoxy resin precursor obtained above is well mixed with filler (aluminum nitride 20 phr, aluminum oxide 20 phr, silicon oxide 30 phr, and aluminum hydroxide 20 phr), bi-hardener mixture 14 phr, Imidazole catalyst 1.5 phr, flow modifier (modified Acrylic acid copolymer (Or Poly-acrylates) 1 phr), and solvent (Dimethyl formamide 20 phr) to form the high thermal conductivity and low dissipation factor adhesive varnish for build-up (combining) additional layers. The viscosity of the adhesive varnish is 21,450 cps. The thermal conductivity coefficient of the cured adhesive varnish is 2.5 W/m-K and the dissipation factor thereof is 0.007(@1 GHz).

TABLE 2

| | | phr (by weight) | |
|---|---|---|---|
| Epoxy resin precursor | Tri-functional epoxy resin | 10 | (4.2%) |
| | Bisphenol A epoxy resin | 25 | (10.6%) |
| | Long-chain/halogen-free | 5 | (2.2%) |
| | epoxy resin | | |
| | Halogen-free/phosphorus- | 40 | (16.9%) |
| | free epoxy resin | | |
| | Rubber-modified or | 20 | (8.4%) |
| | Dimmer-acid-modified | | |
| | epoxy resin | | |
| Filler | Aluminum nitride | 20 | (8.5%) |
| | Aluminum oxide | 30 | (12.7%) |
| | Silicon oxide | 30 | (12.7%) |
| | Aluminum hydroxide | 20 | (8.5%) |
| Hardener | Bi-hardener mixture | 14 | (5.9%) |
| Catalyst | Imidazole catalyst | 1.5 | (0.6%) |
| Flow modifier | Modified acrylic acid | 1 | (0.4%) |
| | copolymer | | |
| | (Or Poly-acrylates) | | |
| Solvent | Dimethyl formamide | 20 | (8.4%) |

| Thermal conductivity | 2.5 | W/m-K |
|---|---|---|
| Dissipation factor (@ 1 GHz) | 0.005 | |
| Glass transition temperature Tg | 151° | C. |
| Thermal degradation temperature Td | 355° | C. |
| Level of flame retardation | V-0 | |
| Viscosity of the adhesive varnish | 21,450 | cps |

Please refer to table 4 as follows. Users can select only two kinds of epoxy resins to form an epoxy resin precursor. For example, as shown in table 4, tri-functional epoxy resin 50 phr and halogen-free/phosphorus-free epoxy resin 50 phr are selected to form an epoxy resin precursor. Above epoxy resin precursor is then well mixed with filler (aluminum nitride 50 phr, aluminum oxide 30 phr, and aluminum hydroxide 20 phr), bi-hardener mixture 19 phr, Imidazole catalyst 0.5 phr, flow modifier (modified Acrylic acid copolymer (Or Poly-acrylates) 1 phr), and solvent (Dimethyl formamide 3 phr) to form the high thermal conductivity and low dissipation factor adhesive varnish for build-up (combining) additional layers. The viscosity of the adhesive varnish is 22,100 cps. The thermal conductivity coefficient of the cured adhesive varnish is 3.0 W/m-K and the dissipation factor thereof is 0.006(@1 GHz).

TABLE 4

| | | phr (by weight) | |
|---|---|---|---|
| Epoxy resin precursor | Tri-functional epoxy resin | 50 | (22.4%) |
| | Halogen-free/phosphorus- | 50 | (22.4%) |
| | free epoxy resin | | |
| Filler | Aluminum nitride | 50 | (22.4%) |
| | Aluminum oxide | 30 | (13.4%) |
| | Aluminum hydroxide | 20 | (8.9%) |
| Hardener | Bi-hardener mixture | 19 | (8.5%) |
| Catalyst | Imidazole catalyst | 0.5 | (0.2%) |
| Flow modifier | Modified acrylic acid | 1 | (0.5%) |
| | copolymer | | |
| | (Or Poly-acrylates) | | |
| Solvent | Dimethyl formamide | 3 | (1.3%) |

| Thermal conductivity | 3.0 | W/m-K |
|---|---|---|
| Dissipation factor (@ 1 GHz) | 0.006 | |
| Glass transition temperature Tg | 171° | C. |
| Thermal degradation temperature Td | 365° | C. |
| Level of flame retardation | V-0 | |
| Viscosity of the adhesive varnish | 22,100 | cps |

According to the present invention, at least two epoxy resins as described above are mixed to form the epoxy resin precursor first. The epoxy resin precursor is then well mixed with the bi-hardener mixture, catalyst, flow modifier, inorganic filler with high thermal conductivity and solvent to produce the high thermal conductivity and low dissipation factor adhesive varnish for build-up (combining) additional layers. Therefore, the present invention has following advantages:
1. The adhesive varnish for build-up (combining) additional insulation layers according to the present invention is effective for greatly lowering the dissipation factor and beneficial for keeping the completeness of signal transmittance.
2. The adhesive varnish for build-up (combining) additional insulation layers according to the present invention has better thermal conductivity and thermostability.
3. By using the varnish for build-up (combining) additional insulation layers according to the present invention, the material loss can be decreased when the yield is elevated.
4. By using the varnish for build-up (combining) additional insulation layers according to the present invention, the holes and surface can be filled and coated (add-up layers) at the same time by consequence it simplifies the manufacturing process effectively.

As disclosed in the above description and attached drawings, the present invention can provide a high thermal conductivity and low dissipation factor adhesive varnish for build-up (combining) additional insulation layers. It is novel and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A high thermal conductivity and low dissipation factor adhesive varnish for (build-up) combining additional insulation layers, used for high-density interconnected printed circuit boards or IC-package substrates, where the high thermal conductivity and low dissipation factor adhesive varnish for (build-up) combining additional insulation layers is formed by well mixing an epoxy resin precursor, a bi-hardener mixture, a catalyst, a flow modifier, an inorganic filler with high thermal conductivity, and a solvent;
wherein the epoxy resin precursor is formed by mixing two epoxy resins with a certain ratio and the epoxy resins are selected from a group including a tri-functional epoxy resin, a rubber-modified or Dimmer-acid-modified epoxy resin, a bromide-contained epoxy resin, a halogen-free/phosphorus-contained epoxy resin, a halogen-free/phosphorus-free epoxy resin, a long-chain/halogen-free epoxy resin, and a bisphenol A (BPA) epoxy resin.

2. The high thermal conductivity and low dissipation factor adhesive varnish for (build-up) combining additional insulation layers as claimed in claim 1, wherein the ratio of the tri-functional epoxy resin is no more than 50%; the ratio of the rubber-modified or Dimmer-acid-modified epoxy resin is no more than 50%; the ratio of the bromide-contained epoxy resin is no more than 80%; the ratio of the halogen-free/phosphorus-contained epoxy resin is no more than 90%; the ratio of the halogen-free/phosphorus-free epoxy resin is no more than 90%; the ratio of the long-chain/halogen-free epoxy resin is no more than 50%; and the ratio of the bisphenol A epoxy resin is no more than 80%.

3. The high thermal conductivity and low dissipation factor adhesive varnish for (build-up) combining additional insulation layers as claimed in claim 1, wherein the amount of bi-hardener mixture is 2˜20 phr (parts per hundred of resins); the amount of the catalyst is 0.1˜5 phr; the amount of flow modifier is 0.1˜5 phr; the amount of inorganic filler with high thermal conductivity is 15˜45 phr; the amount of solvent is 3˜25 phr.

4. The high thermal conductivity and low dissipation factor adhesive varnish for (build-up) combining additional insulation layers as claimed in claim 1, wherein the bi-hardener mixture is formed by well mixing an amine hardener and an acid anhydride hardener.

5. The high thermal conductivity and low dissipation factor adhesive varnish for (build-up) combining additional insulation layers as claimed in claim 4, wherein the ratio of the amine hardener is no more than 10% and the ratio of the acid anhydride hardener is no more than 30%.

6. The high thermal conductivity and low dissipation factor adhesive varnish for (build-up) combining additional insulation layers as claimed in claim 1, wherein the catalyst is an Imidazole catalyst and the ratio thereof is no more than 10%.

7. The high thermal conductivity and low dissipation factor adhesive varnish for (build-up) combining additional insulation layers as claimed in claim 1, wherein the flow modifier is an acrylic acid copolymer or an modified acrylic acid copolymer (or Poly-acrylates), where the average molecular weight of above copolymers is 5,000˜200,000 and the ratio thereof is 0.05˜10%.

8. The high thermal conductivity and low dissipation factor adhesive varnish for (build-up) combining additional insulation layers as claimed in claim 1, wherein the inorganic filler with high thermal conductivity is selected from a group including silicon nitride (SiN), aluminum nitride (AlN), boron nitride (BN), silicon carbide (SiC), aluminum oxide (Al₂O₃), silicon oxide (SiO₂), magnesium oxide (MgO), zinc oxide (ZnO), beryllium oxide (BeO), aluminum hydroxide (Al(OH)₃), and aluminum silicate; and the particle diameter of the inorganic filler is 1˜50 μm and the ratio thereof is no more than 90%.

9. The high thermal conductivity and low dissipation factor adhesive varnish for (build-up) combining additional insulation layers as claimed in claim 1, wherein the solvent is selected from a group including dimethyl formamide (DMF), dimethyl cyclohexylamine (DMCA), methyl ethyl ketone (MEK), and cyclohexanone.
